(19) United States
(12) Patent Application Publication
(10) Pub. No.: US 2016/0292320 A1
(43) Pub. Date: Oct. 6, 2016

(54) IMPROVED METHODS AND SYSTEMS FOR MODELLING GEOLOGICAL FORMATIONS

(71) Applicant: HESS CORPORATION, Houston, TX (US)

(72) Inventor: Douglas A. Palkowsky, Katy, TX (US)

(73) Assignee: Hess Corporation, Houston, TX (US)

(21) Appl. No.: 14/777,539

(22) PCT Filed: Apr. 6, 2015
(86) PCT No.: PCT/US2015/024546

§ 371 Date: Sep. 16, 2015

Related U.S. Application Data
(60) Provisional application No. 61/976,821, filed on Apr. 8, 2014.

(51) Int. Cl. G06F 17/50; G06T 17/05; G01V 99/00

(52) U.S. Cl. CPC G06F 17/5009; G01V 99/005; G06T 17/05

(57) ABSTRACT

Improved methods and systems for efficiently and accurately modelling geological formations are disclosed. A geological model of a region of interest comprises a parent region having a plurality of child regions. A geological model of the parent region is designed. One of the plurality of child regions is extracted from the parent region while maintaining a first parent-child relationship between the child region and the parent region. The geological model of the child region may then be refined or manipulated. The geological model of the child region is then reintegrated with the geological model of the parent region.

### RELATED APPLICATIONS FIELD OF INVENTION

The present application claims priority to provisional application Ser. No. 61/976,821, filed on Apr. 8, 2014, which is incorporated by reference herein in its entirety.

### FIELD OF INVENTION

The present disclosure relates generally to modelling geological formations and more particularly, to improved methods and systems for efficiently and accurately modelling geological formations.

### BACKGROUND

It is often desirable to model various geological formations. Such geological formations may be located onshore and/or offshore. For instance, in order to efficiently retrieve natural resources such as hydrocarbons from geological formations it is desirable to be able to understand the structure, rock, and fluid properties of such formations. Similarly, retrieval of other natural resources often requires an accurate understanding of the geological formation where such resources are located.

One method used to understand the structure of geological formations is to model such formations. Generally, geological modelling of a formation refers to creating a computerized representation of the portions of the earth's crust that form the formation based on geophysical and geological observations that may be made on and/or below the earth's surface. Current approaches for developing geological models have several draw backs. Specifically, there are a number of situations where it may be desirable to be able to selectively divide a region of interest into smaller regions, manipulate the smaller regions and/or integrate the smaller regions back together to assemble an accurate model for the region as a whole.

FIG. 1 depicts an illustrative geological area of interest (AOI) to be modeled. As shown in FIG. 1, the entire region to be modeled may be large in size. For instance, with the increasing use of unconventional methods for producing hydrocarbons, a production region may be a few hundred to several thousand square miles large. In such instances, the region of interest (denoted as 100) may consist of a plurality of smaller regions of interest (denoted as 102A-G). The region of interest 100 as a whole may be referred to as the parent region and each of the smaller regions of interest 102A-G within the parent region of interest may be referred to as a child region. In instances where the parent region 100 is large in size, modelling the parent region as a whole may be problematic. Specifically, modelling such a large area will require the generation of geocellular grids consisting of millions of cells which can be time and resource intensive. Moreover, populating rock and fluid properties for each of these cells contained in such a large model can also be slow and resource intensive. It is unlikely that the same user or users would be interested in constructing and analyzing the whole parent region 100. Instead, it is more likely that different users or teams of users will be responsible for analyzing the different child regions 102A-G or different groups of child regions 102A-G. It is undesirable for each user or group of users to have to load and manipulate data relating to all the cells in the parent region 100 when they are only interested in one or two of the child regions 102A-G. Additionally, when the products of two or more users need to be assembled back together in the context of the parent region, it would be difficult to manage and maintain which updates take precedence. This is one example of an application where it is desirable to be able to independently manipulate various child regions 102A-G of a parent region 100.

FIG. 2 depicts another illustrative application where is desirable to be able to integrate models for multiple child regions. As shown in FIG. 2, a parent region 200 may consist of multiple child regions 202A, 202B, and 202C. In certain illustrative implementations, it is possible that there already exists a geological model for the child regions 202A and 202C but a new geological model is being developed for the child region 202B. Alternatively, a first team may have developed a geological model for the child regions 202A and 202C and a second team may have developed a geological model for the child region 202B. However, the child regions 202A, 202B, and 202C are located adjacent to one another and likely interact. Accordingly, it is likely that an integrated model for the parent region 200 will be more useful than the three distinct models developed for the child regions 202A, 202B, and 202C. As a result, it may be desirable to integrate the models for the child regions 202A, 202B, and 202C into a single geological model.

FIG. 3 depicts another illustrative application where it may be desirable to integrate independently developed geological models of multiple child regions. Specifically, a geological model for a first region 302 or Area of Interest (“AOI”) may be initially developed. It may then become necessary to expand the AOI for the first region 302. For instance, it is possible that specific analysis of the formation of interest may require information about the characteristics of rock formation surrounding region 302. Accordingly, the user may then decide to expand the model to include the rocks located above (over burden), below (under burden) and to the sides (side burden) of the first child region 302. This larger rock region is denoted as a second region 304 in FIG. 3. Since a model for the first region 302 exists, it would be undesirable to require the user to recreate that geological model. Instead, it is desirable to only develop a geological model for the second region 304 and integrate the geological model of the first region 302 and the second region 304 to produce a useful geological model of the whole view of the geological structure of interest. In this illustrative application, the first region 302 becomes a child to the parent region 304. The child-parent region model is created from the child by embedding the existing first region into a larger parent region.

Existing approaches for geological modelling have certain disadvantages that render them unsuitable to carry out such integrated operations. Large regional models are “heavy” with data resulting in visualization and population algorithms that are too time consuming and resource intensive. Therefore, smaller models (child region models) such as field, sub-field, or well scale models are constructed independent of the regional (parent region) models. As a result, it is often difficult to ensure that the smaller models are consistent with the larger regional models. This results in “orphaned” child region models that may be disjointed and inconsistent with the larger regional models. Moreover, maintaining many smaller child region models in the regional context can be time consuming and resource intensive.

For instance, the Petrel® E&P Software Platform available from Schlumberger, Inc. (hereinafter “Petrel”) provides the user with some capabilities for extracting a child region from a larger parent model. Formal hierarchical child models can be created using a technique referred to as local grid refinement (LGR). This technique is common for finite difference fluid flow simulation software. However, when using the LGR technique, a locally refined grid model can only inherit property values from its parent global grid model. Such an LGR cannot be extracted for subsequent manipulation and integrated later on. Similarly, existing global refinement methods produce a single child grid model at a finer resolution that covers the entire AOI of the parent model. Integrating such a refined grid model requires an “upscaling” step. Accordingly, existing modelling methodologies do not support integrating the geological models of multiple child regions (regardless of whether or not they are refined) into a parent region. For example, in Petrel®, the parent region is the “active” component which stores the information relating to the location of its grid cells. Accordingly, in order to incorporate a child region back into a parent region Petrel® needs to query each cell in the parent region model and determine which cells in the child model correspond to the given parent cell. This is a time consuming and resource intensive process, especially in instances where the parent region is large in size and potentially covers a much larger AOI.

Accordingly, there are currently no standard, efficient and accurate methods for successfully dividing a parent region into a plurality of child regions, refining and/or manipulating the child regions and/or integrating the manipulated child regions back into the parent region. Such integration of multiple child regions requires a managed approach when performed by multiple users.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features.

FIG. 1 is a first illustrative example of a parent region having a plurality of child regions.

FIG. 2 is a second illustrative example of a parent region having a plurality of child regions.

FIG. 3 is a third illustrative example of a parent region having a plurality of child regions.

FIGS. 4A-4C depict the implementation of a typical up-scaling process in accordance with the prior art.

FIGS. 5A-5C depict the creation of a grid compatible fine grid from a coarse grid in accordance with an illustrative embodiment of the present disclosure.

FIG. 6 depicts the method steps in accordance with an illustrative embodiment of the present disclosure.

FIG. 7A depicts the selection of a child region from a parent region for further analysis in accordance with an illustrative embodiment of the present disclosure.

FIG. 7B depicts the extraction of a child model and a grand-child model from a parent model in accordance with an illustrative embodiment of the present disclosure.

FIG. 7C depicts the implementation of a fast index approach in accordance with an illustrative embodiment of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to modelling geological formations and more particularly, to improved methods and systems for efficiently and accurately modelling geological formations.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components. It may also include one or more interface units capable of transmitting one or more signals to a controller, actuator, or like device.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, and/or optical carriers; and/or any combination of the foregoing.

The terms “couple” or “couples” as used herein are intended to mean either an indirect or a direct connection. Thus, if a first device couples to a second device, that connection may be through a direct connection or through an indirect mechanical or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections.

The term “parent region” as used herein refers to an area of interest (AOI) which may itself include a plurality of smaller AOIs that are each referred to as a “child region.” The parent region and/or the child region are not limited to any specific size or range of sizes and may be different in size depending on the particular application. The terms “parent model” and “child model” as used herein generally refer to a geological model of a parent region and the geological model of a child region, respectively.

Illustrative embodiments of the present disclosure are described in detail herein. In the interest of clarity, not all features of an actual implementation may be described in this specification. It will of course be appreciated that in the development of any such actual embodiment, numerous implementation-specific decisions are made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure.

In order to accurately and effectively address the shortcomings of the existing methods for modelling of geological formations, it is desirable to develop a method and system that addresses a few issues.

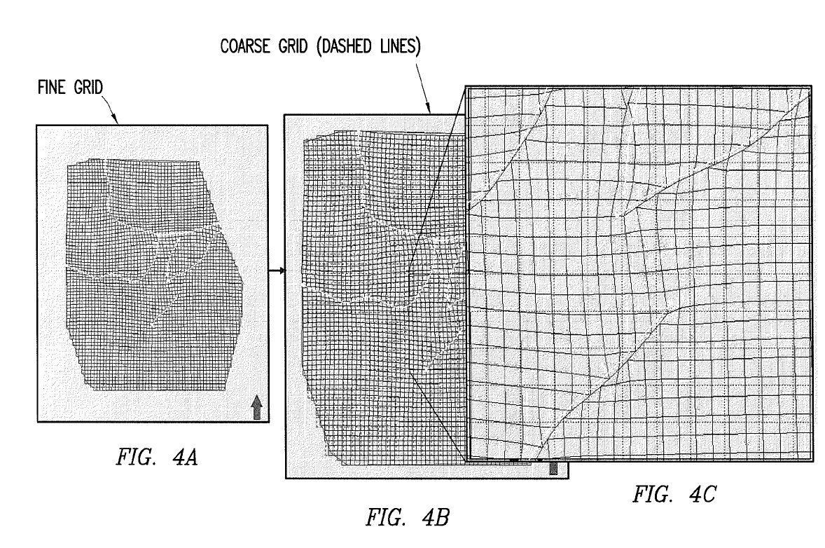

First, it is desirable to achieve “grid compatibility.” The term “grid compatibility” as used herein refers to the correlation between the alignment of cells in a coarser grid as compared to a finer grid corresponding to the same AOI. The term “up-scaling” as used herein refers to the process of resampling a finer geological model having a higher resolution onto a coarser geological model having a lower resolution. For instance, a first geological model may comprise of 100,000 cells. It may be desirable to create a second, more coarse geological model with 10,000 cells. Accordingly, the first geological model may be resampled and “up-scaled” to create the second geological model. This is illustrated and discussed in further detail in conjunction with FIGS. 4A-4C below.

In order to achieve the improved usability without loss of system performance desired, the methods disclosed herein facilitate grid compatibility when sampling, upscaling, or downscaling between grids and provide for access rules to manage user operations on the plurality of child regions that make up a parent region.

The concept of having compatible grids is described in conjunction with FIGS. 4A-C. FIGS. 4A-C depict the implementation of a typical up-scaling process in accordance with the prior art. The typical process entails starting with a fine grid and sampling that fine grid onto a coarser grid. Specifically, FIG. 4A depicts an AOI having a fine grid. It may be desirable to up-scale the AOI of FIG. 4A into a more coarse grid as shown in FIG. 4B. Specifically, FIG. 4B depicts a coarse grid superimposed onto the fine grid of FIG. 4A. FIG. 4C depicts a close up view of the cells of a selected region of FIG. 4B and illustrates the relationship between the cells of the fine grid of FIG. 4A relative to the coarse grid of FIG. 4B. As shown in FIG. 4C, typical up-scaling procedures do not yield grid compatibility. Specifically, as shown in FIG. 4C, the corners of the cells of the fine grid (the cells drawn with solid lines) do not coincide with the corners of the cells of the coarse grid (the cells drawn with dashed lines). As a result, the cell intersections for each cell must be recalculated when up-scaling the model.

The typical up-scaling process shown in FIGS. 4A-C assumes a reasonably common AOI. Moreover, the typical process of translating between a fine grid and a coarse grid utilizes the fine grid as the source grid and the coarse grid as the target grid and is target centric. Specifically, the coarse grid (i.e., the target grid) is the active grid. As a result, in order to populate the cells in the target grid, the system loops over each cell in the target grid and for each cell, the system searches all the cells in the source grid to identify the cells of the source grid that correspond to the particular cell in the target grid and occupy the same spatial region. As a result, the system loops over and searches all the cells in the source grid to identify what may be a very small subset of those cells that correspond to the particular cell in the target grid. As discussed above, the source grid may be large and may include millions of cells making this process highly inefficient.

Moreover, due to lack of grid compatibility, the system must then subdivide the cells of the source grid as necessary to obtain partial cell volume weights in order to populate data in the cells of the target grid. To that end, the system computes the effective property for each target grid cell based on the source grid cells as obtained using the partial cell volume weights to account for grid incompatibility. The effective property for each target grid cell may be determined, for example, using a weighted average such as arithmetic mean, harmonic mean, geometric mean, or flow-based tensor values of the corresponding source grid cells.

This process utilizes significant system resources such as, for example, memory and CPU time. Moreover, the lack of grid compatibility leads to inaccurate results and sampling problems when translating the geological model as shown in FIGS. 4A-C. In addition, any boundary conditions in the finer grid might be lost due to this grid incompatibility.

This approach is particularly prone to errors in instances when the target grid is at a dramatically higher resolution than the source grid or in instances when the source grid and the target grid have different AOI.

Sampling between grids of comparable or different resolutions is more user friendly and efficient and less prone to error if the sampling/up-scaling/downscaling is done in a grid compatible manner. Moreover, it is desirable to develop an approach which accommodates translation between grids with different AOIs. This may be achieved by eliminating the need to search the entire target grid to identify the source grid cells that occupy the same region as a target cell as well as the need to compute complex cell intersections between two grids without having to sacrifice accuracy.

The methods and systems disclosed herein eliminate two main disadvantages of the traditional methods discussed above. First, the methods and systems disclosed herein eliminate the need for calculating values for cell intersections which result from grid incompatibility between a fine grid and its corresponding coarse grid without sacrificing accuracy. Additionally, the methods and systems disclosed herein eliminate the expenditure of system resources to loop through and search the cells of a target grid in order to identify the cells of the source grid that occupy the same spatial locations as each particular cell of the target grid. The methods and systems disclosed herein ensure grid compatibility which prevents an intersection of cells of a fine grid with those of a coarse grid. Once grid compatibility is in place, a fast index approach is used to eliminate the need for a target grid to loop through all its cells and identify the cells of a source grid corresponding to each of its cells.

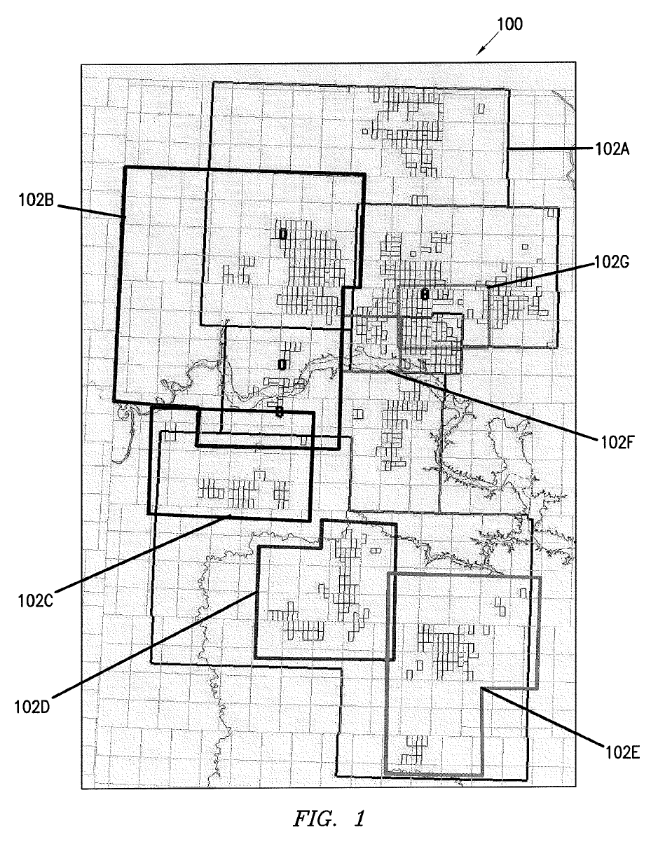

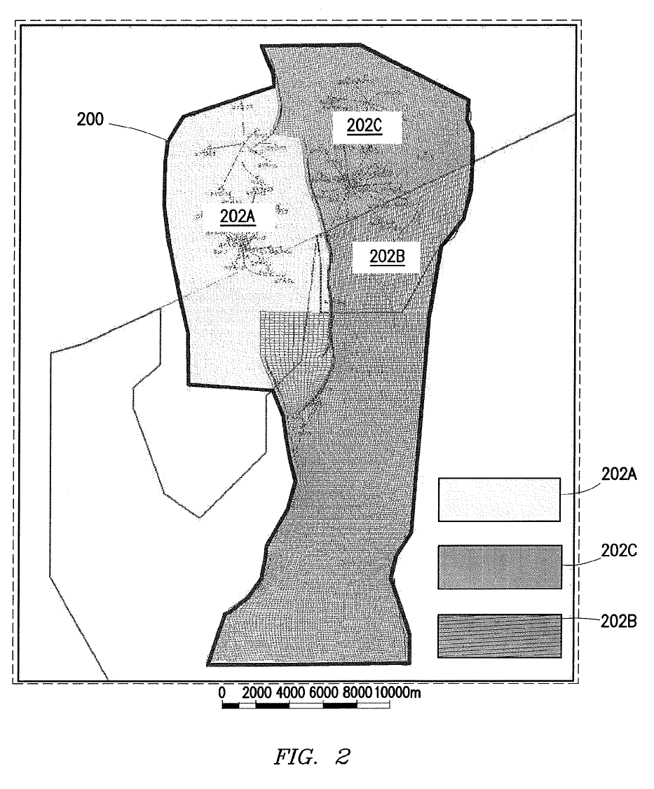

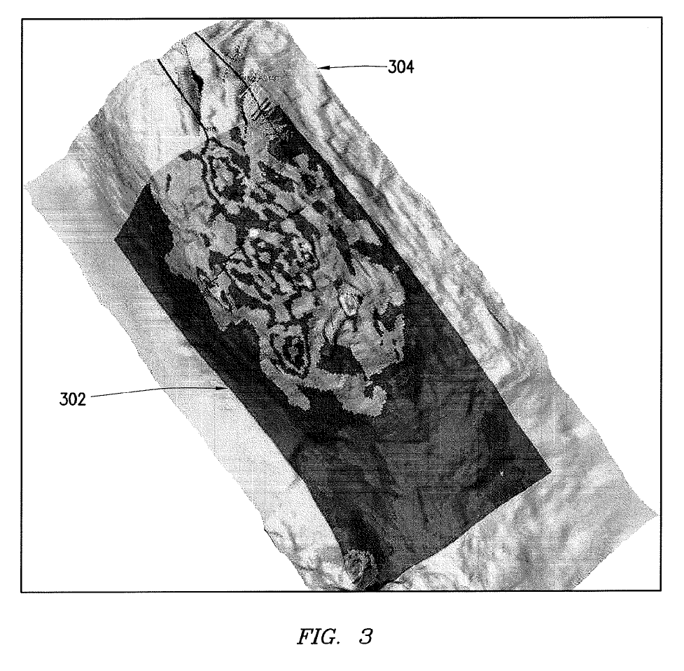

In accordance with the methods and systems disclosed herein, a geological model for a parent region is first developed. The parent region may be a large area comprised of a plurality of child regions such as those examples illustrated and discussed in conjunction with FIGS. 1-3. Once the parent region is modeled, any portion of the parent region may be used as the AOI which can be resampled as discussed in further detail below. One or more child regions may then be extracted from the parent region. One or more users may then refine and/or manipulate a child region before reintegrating it back into the geological model of the parent region.

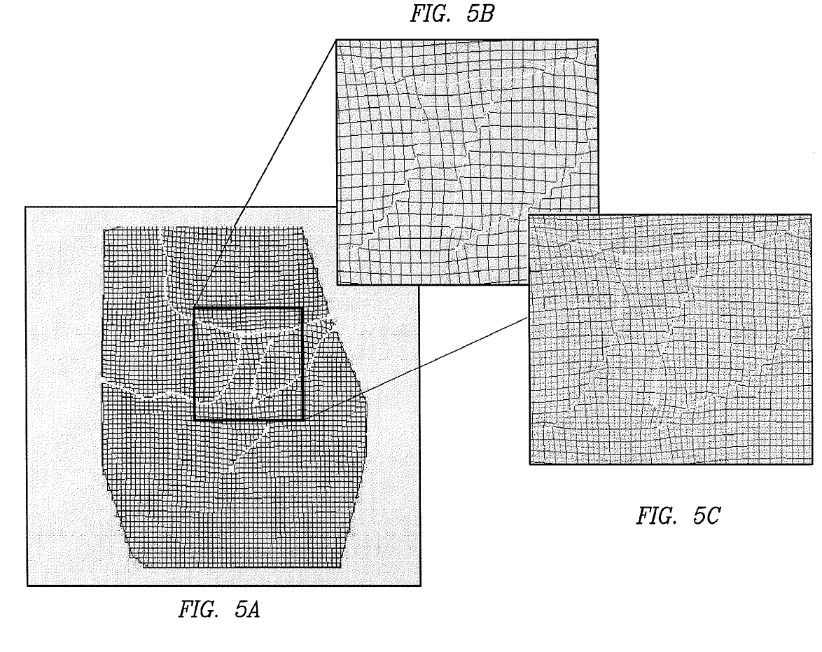

In accordance with an illustrative embodiment of the present disclosure, grid compatibility is maintained when refining any portion of the parent region into a finer grid. Specifically, unlike the traditional approach discussed in conjunction with FIGS. 4A-C, the methods and systems disclosed herein are implemented by first creating the coarse grid and using that coarse grid to create a fine grid. This is discussed in further detail in conjunction with FIGS. 5A-C.

FIG. 5A depicts an AOI from a parent region and FIG. 5B depicts an enlarged view of a portion of FIG. 5A. In accordance with an illustrative embodiment of the present disclosure, this AOI represents the boundary of the coarse grid. This coarse grid may then be refined to create a desired fine grid. Specifically, a user may specify the desired level of refinement. For instance, in the illustrative embodiment of FIG. 5, the coarse grid of FIG. 5A may be refined by dividing each cell in that grid into smaller cells as shown in FIG. 5C. As shown in an enlarged area in FIG. 5C, the coarse grid is subdivided to create the fine grid. Using this refinement method, a user can achieve grid compatibility by having the corners of the cells of the fine grid coincide with the corners of the cells of the coarse grid. This grid compatibility eliminates the need to compute complex cell intersections between the fine grid and the coarse grid without sacrificing accuracy. FIG. 5C depicts the fine grid that results from processing the coarse grid of the parent region as shown in FIG. 5B. The user can then manipulate the data associated with the cells of the fine grid of FIG. 5C as desired. The up-scaling of the grid compatible fine grid of FIG. 5C into the coarse grid of FIG. 5A will now be a simpler process because the cells of the coarse grid correspond to a particular number of cells in the fine grid and there are no cell intersections to be analyzed and calculated.

As would be appreciated by those of ordinary skill in the art, with the benefit of this disclosure, the same process may be repeated to achieve even finer grids having higher resolutions. In each instance, due to grid compatibility, the finer grid may be transferred back into the coarse grid accurately and without having to expend significant system resources to account for the cell intersections that would result from an incompatible grid.

Moreover, the methods and systems disclosed herein eliminate the expenditure of system resources to search for the cells of the source grid that occupy the same spatial locations as each particular cell of the target grid. This is achieved by using a “back tracking” procedure to keep track of the location of each cell of a child region relative to a parent ancestral region as discussed in further detail below.

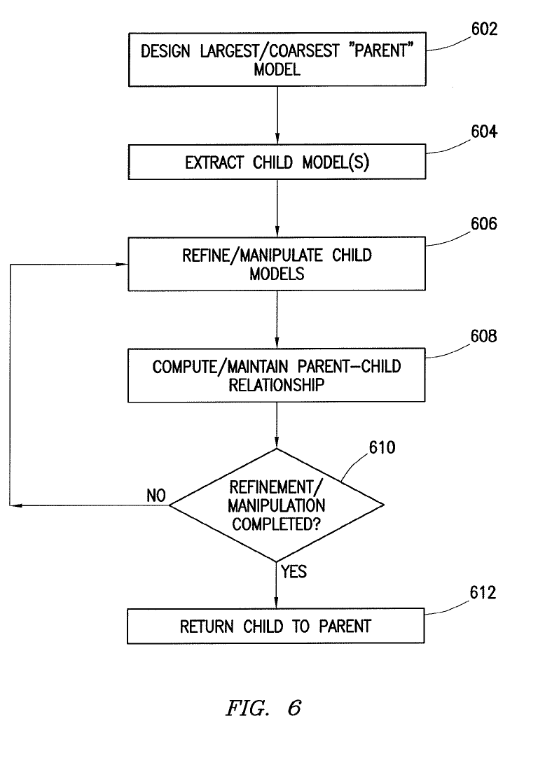

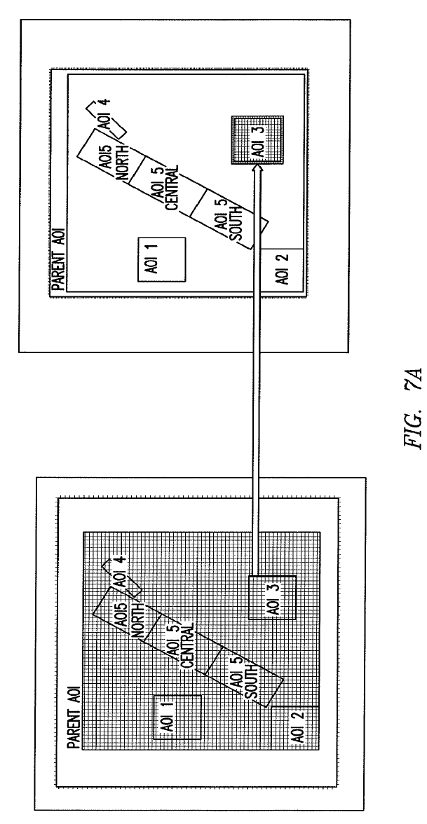

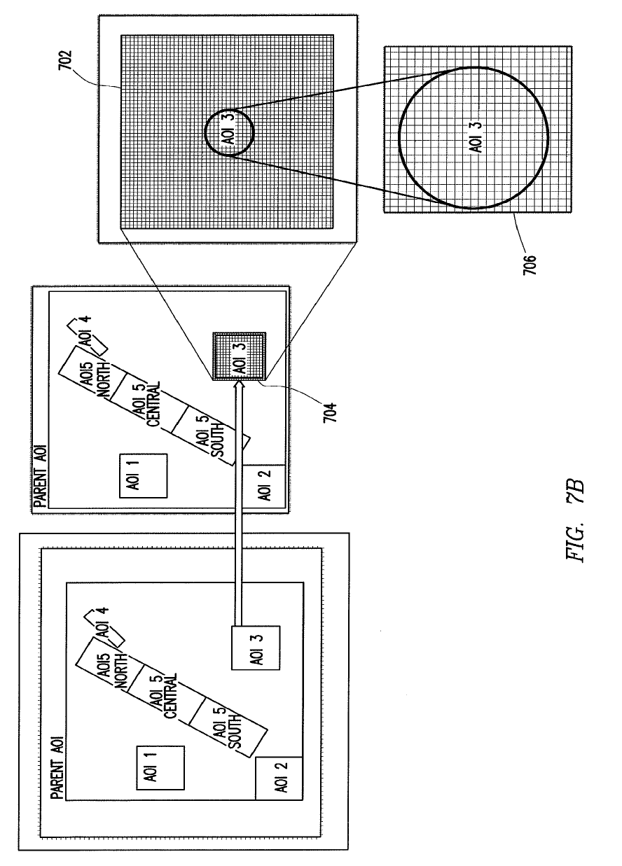

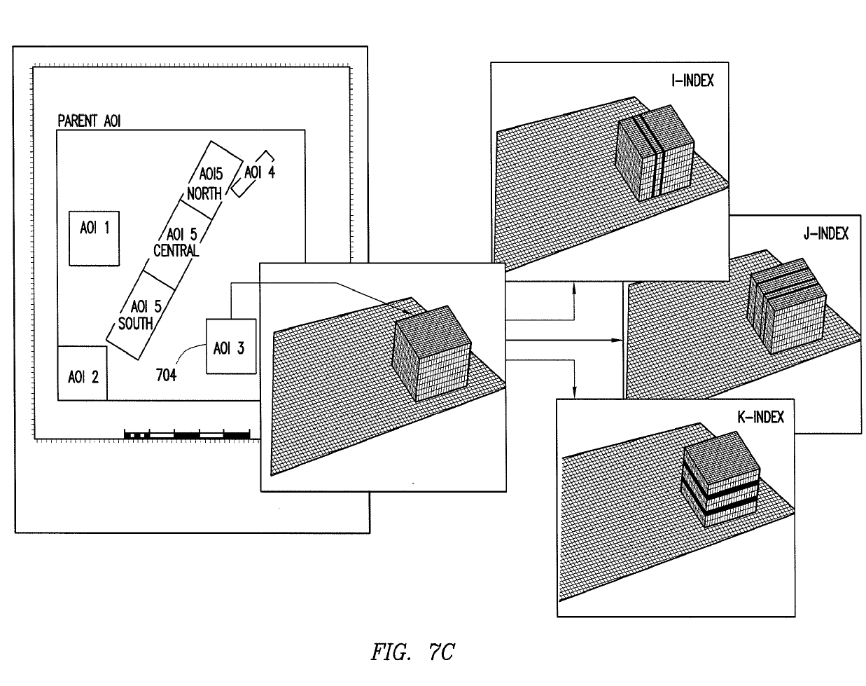

FIG. 6 depicts a flow chart of a process in accordance with an illustrative embodiment of the present disclosure. First, at step 602, a geological model of the largest and coarsest desirable AOI parent region is developed. In certain illustrative embodiments, the parent region modelled may be similar to one of the parent regions discussed in conjunction with FIGS. 1-3. Next, at step 604 a desired child region may be extracted from the parent region AOI. The child region may be any region of interest within the parent region that is selected by a user. For instance, in certain applications involving large acreages such as unconventional hydrocarbon development, the parent region may be large with different teams/users working on different portion of the parent region. Accordingly, each team/user may extract its corresponding child region AOI for refinement and manipulation. FIG. 7A depicts an illustrative parent region with a plurality of child regions and how a user may select one of those child regions (e.g., AOI 3) for further analysis.

Next, at step 606 the child model may be refined. Specifically, as shown in FIG. 7B, the child model 702 may be extracted from the parent model 704 and converted from a coarse grid to a fine grid. Moreover, if desired, a grand-child model 706 may be extracted from the child model 702 for further manipulation. As shown in FIG. 7B, the child model 702 may have a finer grid than the parent model 704 and the grand-child model 706 may have a finer grid than the child model 704. In each instance, the finer grid is created from the coarser grid in the same manner discussed above in conjunction with FIGS. 5A-5C so that grid compatibility is maintained between the parent 704, the child 702 and the grand-child 706 as shown in FIG. 7B. Accordingly, at each step of extraction/refinement there will always be a one-to-one child to parent relationship or a many-to-one child to parent relationship between the cells of a parent and its child. However, because of grid compatibility the present methods and systems can avoid instances of many-to-many child to parent relationships which can lead to an inefficient and error-prone process.

In accordance with an illustrative embodiment of the present disclosure, when extracting the child region from the parent region, the parent-child relationship is maintained at step 608. Specifically, a fast index back tracking approach is used to determine the coordinates of each cell in the parent region. This is shown in further detail in FIG. 7C. As shown in FIG. 7C, for each cell in the child AOI in the parent region (in this example, AOI 3), the I, J, and K “back tracking” indices with regard to the parent region are determined. The associated indices (hereinafter “fast-indices”) for each cell are then stored, specifying the exact spatial location corresponding to that cell in the parent region 704. In certain embodiments, the associated coordinates for each cell may be stored in a computer readable medium. Referring back to FIG. 7B, as the refinements on the cells continue from the parent 704 to the child 702 and to the grand-child 706, in each step the fast indices of the cells are determined with respect to any ancestor and stored allowing an almost immediate return to the ancestral parent built at previous levels of refinement. For instance, when going from the parent model 704 to the child model 702 the back tracking fast indices indicating the location of each cell of the child model 702 in the parent model 704 are generated and stored. Accordingly, when the user returns the child model 702 (source grid) to the parent model 704 (target grid) after manipulation and refinement, the target grid 704 need not loop through each of its cells to identify the particular cells of the child model 702 that correspond to each of its cells. Instead, each cell of the child model 702 knows its exact location in the parent model 704 and can directly find that location and update the data value in that cell location in the parent model 704.

Similarly, when going from the child model 702 to the grand-child model 706, the fast indices indicating the location of each cell of the grand-child model 706 in the child model 702 are generated and stored. Accordingly, when the user returns the grand-child model 706 (source grid) to the child model 702 (target grid) after manipulation and refinement, the target grid 702 need not loop through each of its cells to identify the particular cells of the grand-child model 706 that correspond to each of its cells. Instead, each cell of the grand-child model 706 knows its exact location in the child model 702 and can directly find that location and update the data value in that cell location in the child model 702.

Moreover, the back tracking fast indices indicating the location of each cell of the child model 702 in the parent model 704 are known. Accordingly, in certain implementations, when going from the child model 702 to the grand-child model 706, the fast indices are also updated and stored to indicate the location of each cell of the grand-child model 706 in the parent model 704. Accordingly, the user can directly return the grand-child model 706 to the parent model 704 and bypass the child model 702. When the user returns the grand-child model 706 (source grid) to the parent model 704 (target grid) after manipulation and refinement, the target grid 704 need not loop through each of its cells to identify the particular cells of the grand-child model 706 that correspond to each of its cells. Instead, each cell of the grand-child model 706 knows its exact location in the parent model 704 and can directly find that location and update that cell location in the parent model 706.

As would be appreciated by those of ordinary skill in the art, the levels of refinement available to a user are not limited to a child and grand-child. In the same manner, a user can generate great-grand-children, etc. from the parent model. In this manner, the methods and systems disclosed herein support a recursive ancestry.

The use of fast indices in this fashion significantly improves the system efficiency by reducing the expenditure of resources such as memory and CPU time. Moreover, using back tracking indices each cell knows its location in the parent region (e.g., a larger regional model) and any other intermediate coarser grids at all times. Accordingly, at any point in time and regardless of the levels of refinement from the original parent model, any particular cell from a fine grid can be returned to the parent model (or to any other coarser grid) almost instantaneously.

Turning back to the flow chart of FIG. 6, at step 610 it is determined whether the refinement/manipulation of the extracted child model has been completed. If the refinement has not yet been completed, the process returns to step 606 where the processes of steps 606 and 608 are repeated. However, if the refinement/manipulation of the child model has been completed, the process proceeds to step 612 and the child region model can be returned to the parent region model by reintegrating the child model with the parent model. As discussed above in conjunction with step 608, because the fast indices for each cell of the child model are known, the cells can be returned to their corresponding location in the parent model quickly and efficiently.

In applications where the child model was simply extracted from the parent model for manipulation but was not otherwise refined, the child model and the parent model have the same resolution. The exact location of each cell of the child model in the parent model is known using the fast indices as discussed above in conjunction with step 608. Under these conditions, the integration of the child model with the parent model is a simple transfer of cell data values. In certain implementations, the methods and systems disclosed herein permit a bi-directional transfer of cell data values between the child model and the parent model. Specifically, cell data values may be directed from the parent model to the child model or from the child model to the parent model. Accordingly, the properties (or cell values) of the source grid (child model or parent model) are re-sampled onto the target grid (parent model or child model) using the fast indices which provide the exact location of each cell of the child model in the parent model.

The process implemented in step 612 is different in instances where the child model has been refined and has a higher resolution than the parent model. In such applications, many cells from the finer child model grid correspond to a single cell from the coarser parent model grid. If a transfer from child to parent is required, the data from the child model should be up-scaled when being integrated into the parent model which has a lower resolution and a coarser grid. The exact location of each cell of the child model in the parent model is known using the fast indices as discussed above in conjunction with step 608. Once the single cell in the parent model corresponding to a group of cells in the child model is known, the data values from the group of cells in the child model (“source cells”) may be directed to that particular cell in the parent model (“target cell”). Any suitable averaging methods known to those of ordinary skill in the art may be used to assign a value to the target cell. For instance, in certain implementations, depending on user preferences, a user may assign the minimum data value, the maximum data value, the mode value, the arithmetic mean value, the geometric mean value, the harmonic mean value, the root mean square or the power mean value of the source cells to the target cell. In certain implementations, a facies bias may be added as an enhancement when directing the data values from the source cells to the target cell. Accordingly, the properties of the source cells in a child model, the back tracking fast indices of the source cells in the child model and a set of user defined transfer parameters (e.g., an optional weighting property, an optional bias property and a user defined averaging criteria) may be used to quickly, accurately, and efficiently populate the data in the corresponding target cells in a parent model. If the transfer from parent to child is required, the parent model should be down-scaled. Such down-scaling is simply a special case of the re-sampling described previously and parent cell values are replicated for each child cell corresponding to a single parent cell.

In accordance with methods and systems disclosed herein, sampling errors during up-scaling/resampling are minimized and a resource efficient process is provided which reduces the required memory and CPU time utilized by the information handling system(s) that are used to implement the disclosed steps.

In order to prevent ad hoc system access by different users and ensure system integrity, it may be desirable to also develop access rules and notifications to system components. For instance, access rules may be developed which: (1) allow only certain users to extract or “check out” child model regions from a larger parent model region; (2) allow only one user at a time to check out and edit a child model region and prevent others from editing that child model region until the user has integrated the changes to the child model region back into the parent model region; and (3) notify other users upon check-out, and once a check out child model region has been checked back in. Turning back to the flow chart of FIG. 6, at step 604, it may be desirable to extract a child model region using a secure “check out.” In such implementations, a unique transaction identifier may be created and a check-out event may be recorded and posted for the said child region. Different users may be notified that said region has been secured for pending manipulation. Upon completion of child region manipulation, said child would be returned to the parent at step 612 and a “check in” transaction event may occur against the same unique identifier. Other interested users would be notified of the check-in event. A historical record of all such transactions may be maintained for review and audit purposes. As would be appreciated by those of ordinary skill in the art having the benefit of the present disclosure, other access rules known to those of ordinary skill in the art may also be implemented without departing from the scope of the present disclosure.

In accordance with certain illustrative embodiments, the methods disclosed herein may be performed using an information handling system with computer-readable instructions that perform the recited method steps. For instance, in certain implementations, the methods disclosed herein may be implemented as a plug in to Petrel® using the Ocean Application Programming Interface (“Ocean API”) available from Schlumberger, Inc. Similarly, the methods and systems disclosed herein may be implemented in conjunction with other geological modelling software such as, for example, GOCAD® or SKUA® software available from Paradigm® or the RMS® software available from Emerson Process Management. In such embodiments, the methods and systems disclosed herein will improve system operation by providing for easy integration and compatibility of various child regions into a parent region while allowing the existing software to provide all other necessary functionalities as desired by the user.

A geological model developed in accordance with embodiments of the present disclosure may be utilized in analysis and development of a desired geological formation. For instance, in certain implementations, the geological model developed using the methods and systems disclosed herein may be used during the exploration and production of hydrocarbons. For example, the geological model developed may be used to identify regions of interest that contain hydrocarbons and/or determine the most efficient approach for production of hydrocarbons. Further, the geological models using the methods and systems disclosed herein may be utilized in various steps of performing subterranean operations such as, for example, when drilling a wellbore in the subterranean formation, during the steam injection process, when performing various wireline or logging operations and/or when performing any other operations necessary to remove hydrocarbons from a subterranean formation. For example, when drilling a wellbore in the subterranean formation, a geological model developed in accordance with the methods and systems disclosed herein may be used to characterize the formation(s) being penetrated in order to perform the drilling operations efficiently. As would be appreciated by those of ordinary skill in the art, having the benefit of the present disclosure, the methods and systems disclosed herein may be used in conjunction with other analysis and/or operations relating to development of hydrocarbons or other materials from a geological formation.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

What is claimed is:

1. A method of developing a geological model of a region of interest comprising a parent region having a plurality of child regions comprising:
designing a geological model of the parent region;
extracting one of the plurality of child regions from the parent region,
wherein extracting one of the plurality of child regions from the parent region comprises maintaining a first parent-child relationship between the child region and the parent region;
at least one of refining and manipulating a geological model of the child region; and
reintegrating the geological model of the child region with the geological model of the parent region.

2. The method of claim 1, wherein at least one of refining and manipulating the geological model of the child region comprises:
selecting a portion of the geological model of the child region having a coarse grid;
dividing a selected cell in the coarse grid into a plurality of smaller cells, the plurality of smaller cells forming a fine grid; and
determining a data value for each of the plurality of smaller cells in the fine grid,
wherein a corner of the fine grid coincides with a corner of the selected cell in the coarse grid.

3. The method of claim 2, further comprising manipulating the data value associated with the plurality of smaller cells of the fine grid.

4. The method of claim 3, further comprising up-scaling the plurality of smaller cells of the fine grid into the coarse grid.

5. The method of claim 1, wherein maintaining the first parent-child relationship between the child region and the parent region comprises implementing fast index back tracking.

6. The method of claim 5, wherein the fast index back tracking comprises:
determining fast indices for the child region, wherein the fast indices specify the spatial location corresponding to the child region within the parent region;
storing the fast indices corresponding to the child region; and
using the fast indices corresponding to the child region to return the child region to its location within the parent region.

8. The method of claim 6, wherein the fast indices are stored in a computer readable medium.

7. The method of claim 2, wherein maintaining the first parent-child relationship between the child region and the parent region comprises implementing fast index back tracking, wherein the fast index back tracking comprises:
determining fast indices for each of the plurality of smaller cells of the fine grid relative to the coarse grid, wherein the fast indices for each of the plurality of smaller cells of the fine grid specify the spatial location corresponding to that cell in the coarse grid;
storing the fast indices corresponding to each of the plurality of smaller cells of the fine grid; and
using the fast indices corresponding to each of the plurality of smaller cells of the fine grid to return that cell to its location within the coarse grid.

9. The method of claim 1, wherein a selected one of the plurality of child regions comprises a plurality of grandchild regions, the method further comprising:
extracting one of the plurality of grandchild regions from the selected one of the plurality of child regions, wherein extracting one of the plurality of grandchild regions from the selected one of the plurality of child regions comprises maintaining a second parent-child relationship between the grandchild region and the selected one of the plurality of child regions,
at least one of refining and manipulating a geological model of the grandchild region; and
reintegrating the geological model of the grandchild region with the geological model of the selected one of the plurality of child regions.

10. The method of claim 9, wherein at least one of refining and manipulating the geological model of the grandchild region comprises:
selecting a portion of the geological model of the grandchild region having a coarse grid; and
dividing a cell in the coarse grid into a plurality of smaller cells, the plurality of smaller cells forming a fine grid,
wherein a corner of the fine grid coincides with a corner of the cell of the coarse grid.

11. The method of claim 9, wherein maintaining the second parent-child relationship between the grandchild region and the selected one of the plurality of child regions comprises implementing fast index back tracking.

12. The method of claim 11, wherein the fast index back tracking comprises:
determining fast indices for the grandchild region, wherein the fast indices specify the spatial location corresponding to the grandchild region within the selected one of the plurality of child regions;
storing the fast indices corresponding to the grandchild region; and
using the fast indices corresponding to the grandchild region to return the grandchild region to its location within the selected one of the plurality of child regions.

13. The method of claim 1, wherein the child region has a higher resolution than the parent region and wherein reintegrating the geological model of the child region with the geological model of the parent region comprises up-scaling data from the child region.

14. The method of claim 13, wherein up-scaling data from the child region comprises:
identifying a single cell in the parent region as a target cell;
identifying a group of cells in the child region corresponding to the target cell as the source cells, wherein each source cell has a data value;
obtaining an average of the data values of the source cells; and
directing the average data value of the source cells to the target cell.

15. The method of claim 14, wherein identifying the source cells corresponding to the target cell comprises implementing fast index back tracking.

16. The method of claim 1, wherein extracting one of the plurality of child regions from the parent region further comprises implementing access rules to determine whether a user has permission to access a selected child region.

17. The method of claim 1, wherein extracting one of the plurality of child regions from the parent region further comprises securing the extracted child region from access by another user.

18. The method of claim 17, wherein reintegrating the geological model of the child region with the geological model of the parent region comprises releasing the child region for access by another user.

19. An information handling system having a computer readable medium and a processor, wherein the processor is programmed to develop a geological model of a region of interest comprising a parent region having a plurality of child regions, the processor programmed to:
design a geological model of the region of interest;
extract one of the plurality of child regions from the parent region;
wherein extracting one of the plurality of child regions from the parent region comprises maintaining a parent-child relationship between the child region and the parent region;
at least one of refine and manipulate a geological model of the child region; and
reintegrate the geological model of the child region with the geological model of the parent region.
